(19) United States
(12) Patent Application Publication
(10) Pub. No.: US 2025/0378352 A1
(43) Pub. Date: Dec. 11, 2025

(54) SYSTEM AND METHOD FOR MANAGING DATA IN A DISTRIBUTED SYSTEM BASED ON CUSTOMIZED USER SELECTIONS

(71) Applicant: Dell Products L.P., Round Rock, TX (US)

(72) Inventors: AVIV ZEILIG, Rosh Haayin (IL); LEV MAKLER, Be'er Sheva (IL); AMIR ABU GANIM, Rahat (IL); ANAT PARUSH TZUR, Tel Aviv (IL); OR HERMAN SAFFAR, Ofakim (IL); ELIYAHU ROSENES, Bet Shemesh (IL)

(21) Appl. No.: 18/735,785

(22) Filed: Jun. 6, 2024

(51) Int. Cl. G06N 5/022

(52) U.S. Cl. CPC G06N 5/022

(57) ABSTRACT

Methods and systems for managing data in distributed systems are disclosed. The data may be managed by selectively distributing data based on relevancy of the data for various purposes. The relevancy of different portions of data may be defined by a user. When new portions of data are obtained, the relevancy ascribed to the new portions of data may be used to determine whether to distribute or not distribute the new portions of data. By limiting which portions of data are distributed, computing resources that may otherwise be expended for distributing less relevant data may be reduced.

### FIELD

Embodiments disclosed herein relate generally to user accessibility management. More particularly, embodiments disclosed herein relate to systems and methods to manage user accessibility based on data in a data management system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows in accordance with an embodiment.

FIG. 3 shows a flow diagram illustrating a method of managing use of data to provide computer implemented services in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data in a distributed system. The distributed system may include any number of sub-systems (e.g., data processing systems, devices, servers, etc.) that may cooperatively provide computer-implemented services. To cooperatively perform the computer-implemented services, the sub-systems (e.g., the data processing systems, servers, other devices) may collect, transmit, and/or store the data for use by a user and/or entity. For example, a data processing system may collect the data and transmit the data (e.g., via a wireless communication channel) to a server for storage on behalf of a user (e.g., of the data). The data processing systems, servers, and/or other devices may include a finite quantity of computing resources (e.g., hardware resources and/or software resources) in order to provide the computer-implemented services. The finite quantity of computing resources may limit the quantity and types of computer-implemented services that may be provided at any point in time (e.g., limited collection, transmission, and storage of the data). Consequently, data that may include relevant information necessary to provide the desired computer-implemented services may not be collected, transmitted, and/or stored for a downstream user of the data.

The data may include various types of files (e.g., media, video, audio, etc.) which may consume various amounts of the limited computing resources in collection, transmission, and/or storage of the data based on size and/or quantity of the files. For example, the data may include video surveillance (e.g., video files) of a dog daycare facility during hours of operation (e.g., 7 a.m. until 7:00 p.m.) which may require large bandwidth and high computational power to collect and transmit to an external entity (e.g., servers operated by a user or management team of the dog daycare facility).

To manage the consumption of copious amounts of computational power and communication bandwidth, a data management framework that selectively identifies and transmits relevant portions of data for a specific user may be implemented. The data management framework may provide tailored data reduction to limit the amount of data being processed, analyzed, transmitted, and/or otherwise managed based on a users' specific needs. By doing so, fewer computing resources may be expended for managing portions of data that are irrelevant and/or not of interest to a user or entity of the data. As such, the amount and efficiency of the computing resources usable to process, transmit, store, and/or otherwise manage the portions of data that are relevant to the user or entity of the data may be increased.

In an embodiment, a method for managing data in a distributed system is disclosed. The method may include obtaining, from a data originator of the distributed system, a portion of the data; tagging, using a template and a pre-trained model, the portion of the data to obtain a tagged portion of the data; making, using the tagged portion of the data and a set of rules keyed to tags that are applicable to the data within the distributed system, a determination regarding whether the portion of the data is to be provided to a remote entity of the distributed system that is remote to the data originator; in a first instance of the determination where the portion of the data is not to be provided to the remote entity; not providing the portion of the data to the remote entity, and using at least one tag from the tagged portion of the data to refine the pre-trained model to reduce a likelihood of the pre-trained model tagging other portions of the data with any tags that are not deemed to be relevant by the set of the rules; and in a second instance of the determination where the portion of the data is to be provided to the remote entity: providing the portion of the data to the remote entity to provision computer implemented services using the data.

The method may also include: prior to obtaining the portion of the data: providing, to a user via a user interface, a list of tags to allow the user to select at least one tag of the list of tags, the list of tags comprising: a first portion of tags based on a representative sample of the data, a second portion of tags based on an industry in which the data originator operates and tags from other entities in the industry, and a third portion of tags based on user input; obtaining, via the user interface, a selection of the at least one tag of the list of tags; and generating, using the selection, the set of rules associated with each tag selected by the user.

Tagging the portion of the data may include: performing a multistage process in which information from the portion of the data is extracted to obtain extracted information and the extracted information is placed into a predefined format interpretable by a person.

The multistage process may include using the pre-trained model to obtain unstructured textual descriptions for the portion of the data, the unstructured textual descriptions being the information; and using the template and a language model to refine the unstructured textual descriptions to obtain structured textual descriptions for the portion of the data to obtain the tagged portion of the data.

The language model may be adapted to populate the template based, at least in part, on the unstructured textual descriptions of information.

The set of rules that are be keyed to the tags may be based, at least in part, on user input obtained using a user interface.

The set of rules that are keyed to the tags may be based on historical data and representative data, the representative data being from the data originator and the historical data from a different data originator.

Not providing the portion of the data to the remote entity may include at least temporarily storing the tagged portion of the data locally, and marking the tagged portion of the data to prevent distribution to the remote entities.

Using at least one tag from the tagged portion of the data to refine the pre-trained model may include: ascribing, to the at least one tag, a negative reward, and performing a reinforced learning process using the negative reward and the at least one tag to obtain an updated pre-trained model that is less likely to identify instances of the at least one tag in subsequently obtained portions of the data.

The updated pre-trained model may be adapted to identify were entities depicted in portions of the data than the pre-trained model is likely to identify.

The pre-trained model may be adapted to identify: in video data: activities depicted in a scene in the video data; objects depicted in the scene in the video data; relative positions of the objects; in audio data: speech using automated speech recognition and/or speech classification; noise; in textual data: metadata regarding a document in which the textual data is stored.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

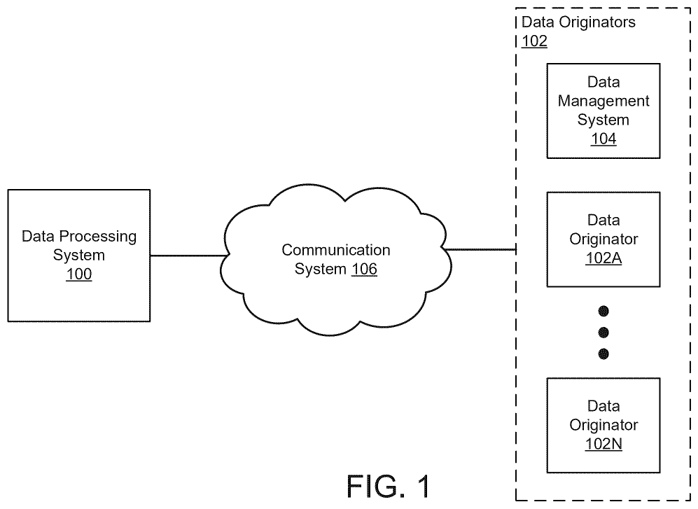

Turning to FIG. 1, a block diagram illustrating a system in accordance with an embodiment is shown. The system shown in FIG. 1 may provide computer-implemented services utilizing data obtained from any number of data originators and provided to any number of remote entities (e.g., data processing systems that are remote to the data originators) to provision the computer-implemented services. The computer-implemented services may include any type and quantity of computer-implemented services. For example, the computer-implemented services may include database services, data processing services, electronic communication services, and/or any other type of computer-implemented services.

To facilitate the computer-implemented services, the system may include data originators 102. Data originators 102 may include any number of data originators. For example, data originators 102 may include one data originator (e.g., data originator 102A) or multiple data originators 102 (e.g., 102A-102N). Each data originator of data originators 102 may include hardware and/or software components configured to obtain data, process data, store data, provide data to other entities, and/or to perform any other tasks to facilitate performance of the computer-implemented services.

The data collected from data originators 102 may include any quantity, size, and type of data (e.g., media, video, audio, etc.). For example, video data of multiple dogs participating in various activities at a dog daycare facility may be obtained from a camera (e.g., data originator 102) located at the dog daycare facility for use by an owner of the dog daycare facility and/or authorized user (e.g., via associated devices).

The data collected by data originators 102 may be provided to data processing system 100. While illustrated with respect to a single data processing system, the system of FIG. 1 may include any number of data processing systems to which the data may be provided to. Data processing system 100 may include any type of computing devices (e.g., personal computing device, servers, data centers, etc.) that provide the computer-implemented services to users and/or other computing devices operably connected to data processing system 100.

By providing the data to data processing system 100, the data may be usable for a variety of purposes. For example, in video surveillance context, the data may be usable for safety purposes (e.g., identifying malicious activities, hazardous conditions, etc.), operation management purposes (e.g., monitoring operations), etc. While described with respect to the video surveillance context, it will be appreciated that data may be provided to data processing system 100 for other purposes and/or with respect to another context. For example, the data may be relevant for other types of services, uses, etc. without departing from embodiments disclosed herein.

However, providing data from data originators 102 to data processing system 100 may consume limited computing resources and/or communication bandwidth available to data originators 102 and/or data processing system 100. For example, data originators 102 may have a finite amount of computing resources for collecting and transmitting data. If the computing resources are consumed, additional data may not be transmitted in an efficient and/or timing manner in order to provide the computer-implemented services. In addition, data processing system 100 may have a finite amount of storage resources for storing data. If the storage resources are consumed, the additional data may not be stored in data processing system 100 thereby limiting the use of the data and computer-implemented services provided with the data.

In addition, some portions of the data collected by data originators 102 may not be relevant for use by the user and/or entity for which the data is being collected. For example, in relation to the dog daycare facility, an owner of the dog daycare may be interested in video data that is relevant to identifying the number of dogs within the daycare facility. If video data that does not include relevant information to identify the number of dogs within the facility is obtained, the computing resources available to manage relevant portions of data may be decreased.

In general, embodiments disclosed herein may provide methods, systems, and/or devices for managing data in a distributed system. To manage data in the distributed system, data management system 104 may tag portions of data obtained from a data originator to efficiently identify information in the portion of data. A list of tags indicated from the tagged portions of data and other tags relevant to a specific user and/or based on a type of industry in which the data originator operates may be presented to the user (e.g., of the portion of data) to obtain selection of tags relevant to the user. Fine-tuning methods may be used to refine information being tagged by the pre-trained model to identify relevant portions of data and obtain updated pre-trained models customized on a per user basis.

To provide its functionality, data management system 104 may (i) establish a set of rules that are keyed to tags applicable to the data, (ii) obtain, from a data originator of the distributed system, a portion of the data, (iii) perform a multistage process, using a template and a pre-trained model, to tag the portion of the data to obtain a tagged portion of the data, (iv) making, using the tagged portion of the data and the set of rules keyed to the tags, a determination regarding whether the portion of the data is to be provided to a remote entity (e.g., that is remote to the data originator), (v) based on the determination, provide the portion of the data to remote entities and/or generate reinforcement information to use to refine the pre-trained model to obtain an updated pre-trained model, and/or (vi) perform any other processes in order to facilitate data management services.

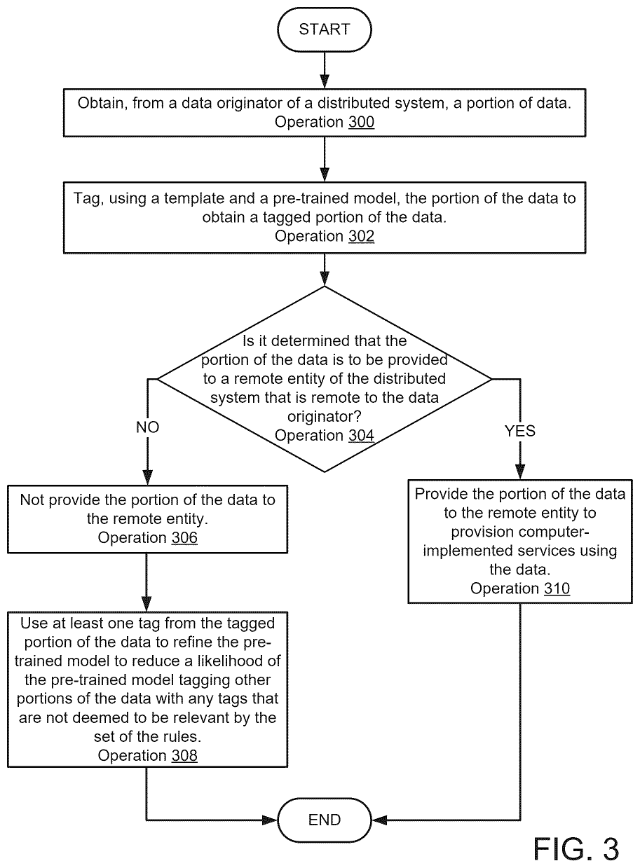

When providing its functionality, data processing system 100, data originators 102, and/or data management system 104 may perform all, or a portion, of the method and/or actions shown in FIG. 3.

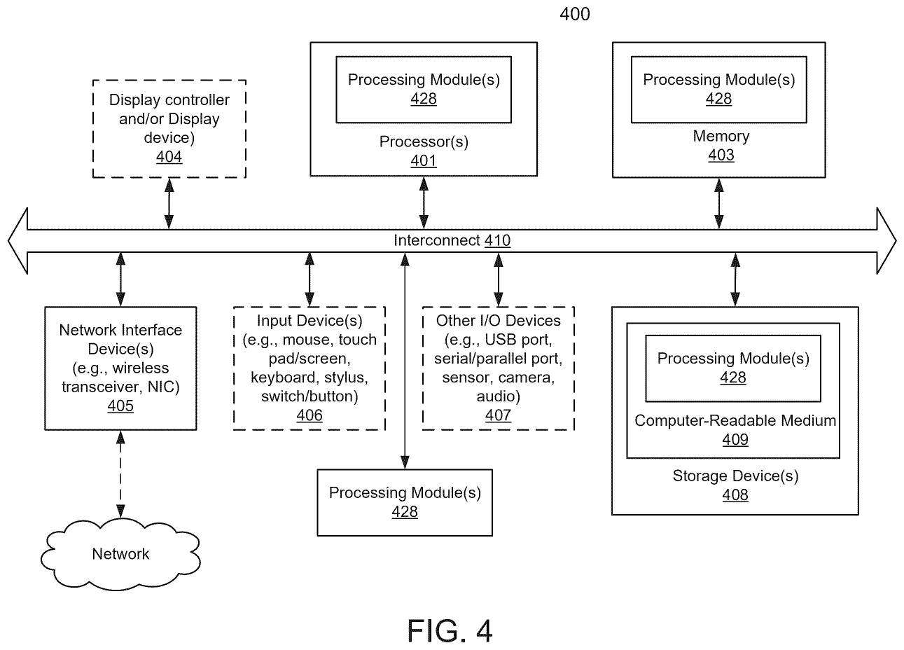

Data processing system 100, data originators 102, and/or data management system 104 may be implemented using a computing device such as a host or server, a personal computer (e.g., desktops, laptops, and tablets), a “thin” client, a personal digital assistant (PDA), a Web enabled appliance, or a mobile phone (e.g., Smartphone), an embedded system, local controllers, and/or any other type of data processing device or system. For additional details regarding computing devices, refer to FIG. 4.

In an embodiment, one or more of data processing system 100, data originators 102, and/or data management system 104 are implemented using an internet of things (IoT) device, which may include a computing device. The IoT device may operate in accordance with a communication model and/or management model known to data processing system 100, data originators 102, and/or data management system 104, data sources (not shown), and/or other devices.

Any of the components illustrated in FIG. 1 may be operably connected to each other (and/or components not illustrated) with a communication system 106. In an embodiment, communication system 106 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

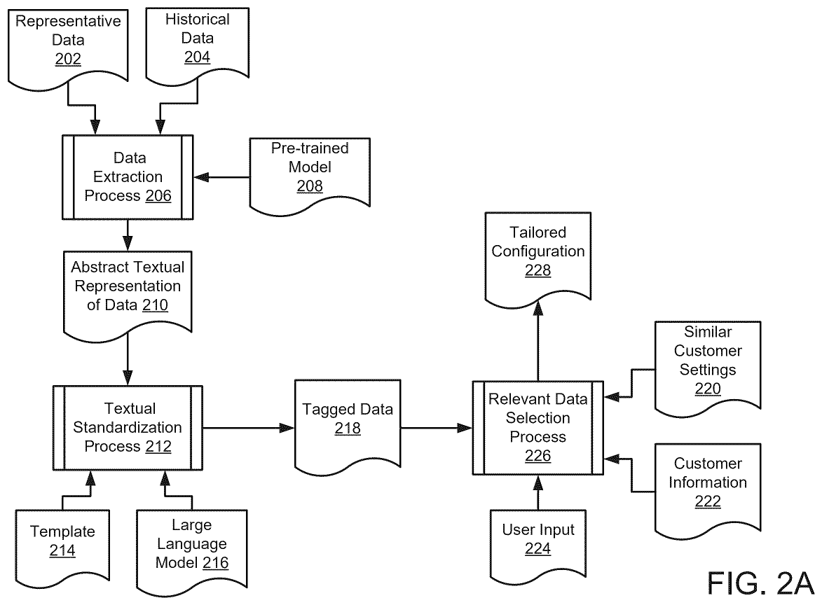

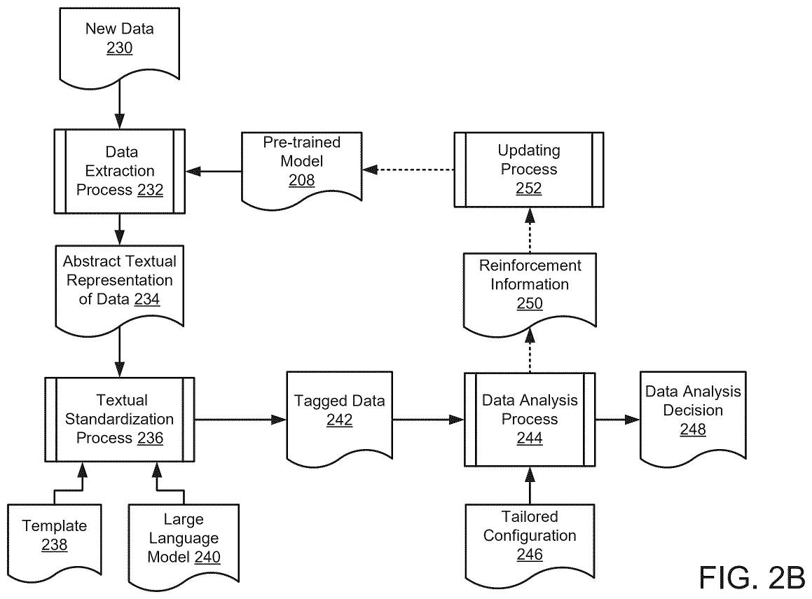

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 202, 208, etc.) is used to represent data structures, and a second set of shapes (e.g., 206, 212, etc.) is used to represent processes performed using and/or that generate data.

Turning to FIG. 2A, a first data flow diagram illustrating data flows, data processing, and/or other operations that may be performed by the system of FIG. 1 in accordance with an embodiment is shown. The data flows, data processing, and/or other operations may be performed to obtain tailored configurations for users to identify data relevant to the respective user.

To obtain tailored configurations for users to identify data relevant to the respective user, data extraction process 206 may be performed. During data extraction process 206, representative data 202 and historical data 204 may be ingested into a pre-trained model (e.g., AI model, inference model, etc.). Representative data 202 and historical data 204 may be obtained from different data originators. For example, representative data 202 may be obtained from data originator 102A and historical data 204 may be obtained from data originator 102B.

Once ingested, representative data 202 and historical data 204 may be subjected to any number of data extraction processes. Some of the data extraction processes may be performed based on the type of data defined by schema corresponding to the type of data. For example, pre-trained model 208 may be adapted to identify (i) activities and/or objects (and/or relative positions of the objects) depicted in a scene in video data (e.g., type of data), (ii) speech using automated speech recognition and/or speech classification noise in audio data, (iii) metadata regarding a document in which textual data is stored, and/or (iv) any other information in other types of data. Although three types of data are discussed above, the pre-trained model may be adapted to identify any number and/or any type of data, without departing from one or more embodiments disclosed herein.

The result of performing data extraction process 206 may be unstructured textual descriptions of information extracted from representative data 202 and/or historical data 204 may be obtained. Through data extraction process 206, abstract textual representation of data 210 may be obtained. Abstract textual representation may include unstructured textual descriptions of information from the data (e.g., representation data 202 and/or historical data 204).

For example, abstract textual representation of data 210 may include a list of unstructured text that represents information from the data (e.g., representation data 202 and/or historical data 204). For example, in the dog daycare context, video data of three dogs from different breeds (e.g., golden retriever, Australian shepherd, and poodle) may be depicted playing with a ball in an enclosed outside area of the dog daycare facility. Through data extraction process 206, the pre-trained model 208 may extract information such as “dogs”, “ball”, and “grass” (e.g., abstract textual representation of data 210).

Abstract textual representation of data 210 may be used to generate structured data that is interpretable by an individual. Abstract textual representation of data 210 may be used during textual standardization process 212.

Textual standardization process 212 may be performed to refine abstract textual representation of data 210 into a structured format that is interpretable by a person. Textual standardization process 212 may transform the unstructured textual descriptions (e.g., abstract textual representation of data 210) to a predetermined structured format in order to obtain structured textual descriptions for the portion of the data included as tagged data 218.

To do so, textual standardization process 212 may obtain a template (e.g., template 214) usable by a language model (e.g., large language model 216) to organize the unstructured textual descriptions of the data (e.g., abstract textual representation of data 210) into structured textual descriptions of the portion of the data (e.g., tagged data 218).

Large language model 216 may be adapted to populate the template (e.g., template 214) based, at least in part, on the unstructured textual descriptions (e.g., obtained and/or generated by data extraction process 206 as described above). The template 214 may be a set of information and/or instructions that may be used by one or more inference models (e.g., large language models (LLMs) such as large language model 216) to generate one or more inferences (e.g., prediction/outputs) in a structured format using in-context learning techniques. For example, template 214 may include information such as “there are X number of dogs present” and large language model 216 would identify “three dogs” (e.g., from abstract textual representation of data 210) and replace the “X” with the number “three” to represent the information in a structured format interpretable by a user.

The structured textual descriptions of the portion of data may be complied by the textual standardization process 212 into tagged data 218. Tagged data 218 may be used to efficiently allow selection of information relevant to the user (e.g., of the portion of data). Tagged data 218 may include “tags” representing the structured textual descriptions of information extracted from representative data 202 and/or historical data 204. For example, tagged data 218 may include a list of identifiers such as “dogs”, “trees”, “ball”, and/or any other identifiers for information depicted in a scene of video data for the dog daycare facility. Tagged data 218 may be used during relevant data selection process 226.

Relevant data selection process 226 may be performed to identify portions of data that are relevant to a user.

Relevant data selection process 226 may allow selection of tags (e.g., for portion of data) by a user to identify relevant portions of data for the user. During relevant data selection process 226, tagged data 218, similar customer settings 220, and customer information 222 may be used to compile a list of tags to allow a user to select the tags relevant to the user via a user interface. For example, a list of tags may be presented to a user via a user interface.

Similar customer settings 220 may be used to provide an additional portion of tags relevant to an industry in which the data originator operates and tags from other entities in the industry. Similar customer settings 220 may include information identifying tags (e.g., structured textual descriptions) relevant to information for an associated industry in which the user of the data operates in (e.g., data originator). For example, in the dog daycare context, similar customer settings 220 may include one or more tags used by other dog daycare entities that identifies relevant information for the dog daycare industry. Similar customer settings 220 may provide additional information and/or tags that may have not been obtained and/or generated from representative data 202 and/or historical data 204 (e.g., via data extraction process 206).

Customer information 222 may be used to provide an additional portion of tags relevant to the customer and/or user of the data. Customer information 222 may include tags (e.g., identifiers and/or structured textual descriptions) representing information that may be relevant to the specific customer and/or user. Customer information 222 may be obtained from a user via user input using the user interface and used to generate the compiled list of tags for selection.

As part of relevant data selection process 226, user input 224 may be obtained in order to generate a set of rules associated with the tags selected by the user (e.g., tailored configuration). For example, user input 224 may include input (e.g., obtained via a user interface) from a user of the data indicating a selection of tags that are relevant to the user.

The result of performing relevant data selection process 226 may be a set of rules keyed to tags that are applicable to the data with the distributed system. Through relevant data selection process 226, tailored configuration 228 may be obtained. Tailored configuration 228 may include a list of tags that are keyed to a set of rules. Tailored configuration 228 may be used to efficiently identify whether to provide the portion of data to a remote entity of the distributed system (e.g., that is remote to the data originator). Refer to FIG. 2B for additional details regarding implementing tailored configurations.

Turning to FIG. 2B, a second data flow diagram illustrating data flows, data processing, and/or other operations that may be performed by the system of FIG. 1 in accordance with an embodiment is shown. The data flows, data processing, and/or other operations may be performed during updating a pre-trained model to identify relevant portions of data.

To update the pre-trained model, new data 230 may be ingested into pre-trained model 208 during data extraction process 232. New data 230 may include a new portion of data obtained from a data originator (e.g., 102A shown in FIG. 1).

Similar to data extraction process 206, data extraction process 232 may perform various extraction processes to extract information from new data 230 to obtain abstract textual representation of data 234. For example, data extraction process 232 may extract hidden information from new data 230 and generate unstructured textual descriptions to represent the hidden information. The unstructured textual descriptions of the information extracted from new data 240 may be compiled into abstract textual representation of data 234.

Similarly to abstract textual representation of data 210, abstract textual representation of data 234 may include unstructured textual descriptions of the information extracted from the portion of data (e.g., new data 230).

Once obtained, abstract textual representation of data 234 may be used during textual standardization process 236 to obtain tagged data 242. During textual standardization process 236, large language model 240 (e.g., similar to large language model 216) may utilize template 238 to transform the unstructured textual descriptions into structured textual descriptions for the portion of the data (e.g., new data 230). The structured textual descriptions may include tags or identifiers of information extracted during data extraction process 232.

Once obtained, tagged data 242 may be used to perform data analysis process 244. During data analysis process 244, the tagged data (e.g., tagged data 242) may be analyzed with respect to the tags identified as relevant to the user to determine whether the portion of the data is to be provided to a remote entity (e.g., data procession system 100 and/or other components shown in FIG. 1).

To do so, the tags for the portion of data (e.g., tagged data 242) may be compared to the set of rules keyed to the tags (e.g., tailored configuration 246) to identify whether the portion of the data is to be provided to the remote entity (e.g., that is remote to the data originator). For example, tags indicated by tagged data 242 may be used as a key to perform a look up within tailored configuration 246 to identify the set of rules associated with the tags to determine whether the tagged data should be provided to the remote entity.

As a result of performing data analysis process 244, data analysis decision 248 may be obtained. Data analysis decision 248 may include a result of whether the portion of the data is determined to be provided to the remote entity based on the tags deemed to be relevant by the set of rules (e.g., established by the user of the data). For example, data analysis decision 248 may indicate a determination to provide the portion of the data to the remote entity if the tags included in tagged data 242 are deemed to be relevant based on the set of rules associated with the tags.

Conversely, data analysis decision 248 may indicate a determination to not provide the portion of the data to the remote entity if the tags included in tagged data 242 are not deemed to be relevant based on the set of rules associated with the tags. For example, data analysis decision 248 may include a set of instructions indicating to temporarily store tagged data 242 locally (e.g., on a local hard drive of data originator and/or data management system) and mark tagged data 248 to prevent distribution of the portion of data to the remote entity.

Based on the data analysis decision 248, reinforcement information 250 may be generated as a result and used to perform updating process 252. Reinforcement information 250 may include at least one tag (e.g., of tagged data 242) and a negative reward associated with the at least one tag. The negative reward may include a signal of a negative result associated with the tag indicated by the tagged data 242.

Updating process 252 may be performed to refine the pre-trained model using reinforcement information 250 to obtain an updated pre-trained model that is less likely to identify instances of the tags deemed as non-relevant in subsequently obtained portions of data. Updating process 252 may include refining the amount of tags used by the pre-trained model in performing data extraction processes (e.g., data extraction process 232) in the future to reduce a likelihood of the pre-trained model tagging other portions of the data with any non-relevant tags. To do so, the at least one tag and associated negative reward (e.g., indicated by reinforcement information 250) may be used to remove and/or delete the at least one tag from the tags used by the pre-trained model during data extraction processes for new data obtained in the future.

The updated pre-trained model may be more likely to tag portions of data that are more relevant (e.g., to a user of the data) and decrease the amount of computing resources utilized to tag less and/or irrelevant portions of data.

Turning to FIG. 3, a flow diagram illustrating a method of managing data in a distributed system in accordance with an embodiment is shown. The method may be performed by any of data processing system 100, data originators 102, data management system 104, and/or other entities without departing from embodiments disclosed herein.

Prior to operation 300, the data management system (and/or component of the data management system) may (i) provide, to a user via a user interface, a list of tags to allow the user to select at least one tag of the list of tags, (ii) obtain, via the user interface, a selection of the at least one tag of the list of tags, and/or (iii) generate, using the selection, the set of rules associated with each tag selected by the user.

At operation 300, a portion of data may be obtained from a data originator of a distributed system. The portion of data may be obtained by (i) receiving the portion of data from another device, (ii) reading the portion of data from storage, and/or (iii) performing any other methods. The portion of data may be received from another device by (i) requesting the portion of data from the data management system and receiving the portion of data in a message that is responsive to the request, (ii) receiving the portion of data in unprompted messages from the data management system, and/or (iii) via other methods.

At operation 302, the portion of the data may be tagged using a template and a pre-trained model to obtain a tagged portion of the data. Tagging the portion of the data may include performing a multistage process in which information from the portion of the data is extracted to obtain extracted information and the extracted information is placed into a predefined format interpretable by a person.

The multistage process may include (i) using the pre-trained model to obtain unstructured textual descriptions for the portion of the data, the unstructured textual descriptions being the information, and (ii) using the template and a language model to refine the unstructured textual descriptions to obtain structured textual descriptions for the portion of the data to obtain the tagged portion of the data.

Using the pre-trained model to obtain unstructured textual descriptions for the portion of the data may be facilitated by (i) ingesting the portion of the data into the pre-trained model, (ii) performing screening processing based on the type of the data to identify unstructured textual descriptions of information, and/or (iii) performing any other methods.

Using the template and the language model to refine the unstructured textual descriptions may be facilitated by (i) ingesting the unstructured textual descriptions into the language model, (ii) performing any natural language processing using the template and the language model to transform the unstructured textual descriptions into structured textual descriptions, and/or (iii) performing any other methods.

At operation 304, a determination may be made regarding whether the portion of the data is to be provided to a remote entity of the distributed system that is remote to the data originator. The determination may be made by using the tags as a key to perform a look up within the set of rules to identify whether the portion of the data is to be provided to the remote entity. For example, the tags from the tagged portion of the data may be used as a key to perform a look up to identify the associated set of rules that indicates whether the tagged portion of the data is relevant to the user and therefore should be provided to the remote entity.

At operation 310, the portion of the data may be provided to the remote entity to provision computer-implemented services using the data. The portion of the data may be provided by (i) sending the portion of the data via electronic communication to the remote entity, (ii) placing the portion of the data in a storage device readable by the remote entity, and/or (iii) by any other methods.

The method may end following operation 310.

Returning to operation 304, if it is determined that the portion of the data is not to be provided to the remote entity (e.g., the determination is “No” at operation 304), then the method may proceed to operation 306. At operation 306, the portion of the data may not be provided to the remote entity. Not providing the portion of the data may include at least temporarily storing the tagged portion of the data locally, and marking the tagged portion of the data to prevent distribution to the remote entities.

At operation 308, at least one tag from the tagged portion of the data may be used to refine the pre-trained model to reduce a likelihood of the pre-trained model tagging other portions of the data with any tags that are not deemed to be relevant by the set of the rules. Using at least one tag from the tagged portion of the data to refine the pre-trained model may include: (i) ascribing, to the at least one tag, a negative reward, (ii) performing a reinforced learning process using the negative reward and the at least one tag to obtain an updated pre-trained model that is less likely to identify instances of the at least one tag in subsequently obtained portions of the data, and/or (iii) any other methods.

The method may end following operation 308.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing data in a distributed system, the method comprising:
obtaining, from a data originator of the distributed system, a portion of the data;
tagging, using a template and a pre-trained model, the portion of the data to obtain a tagged portion of the data;
making, using the tagged portion of the data and a set of rules keyed to tags that are applicable to the data within the distributed system, a determination regarding whether the portion of the data is to be provided to a remote entity of the distributed system that is remote to the data originator;
in a first instance of the determination where the portion of the data is not to be provided to the remote entity;
not providing the portion of the data to the remote entity, and
using at least one tag from the tagged portion of the data to refine the pre-trained model to reduce a likelihood of the pre-trained model tagging other portions of the data with any tags that are not deemed to be relevant by the set of the rules; and
in a second instance of the determination where the portion of the data is to be provided to the remote entity:
providing the portion of the data to the remote entity to provision computer implemented services using the data.

2. The method of claim 1, further comprising:
prior to obtaining the portion of the data:
providing, to a user via a user interface, a list of tags to allow the user to select at least one tag of the list of tags, the list of tags comprising:
a first portion of tags based on a representative sample of the data,
a second portion of tags based on an industry in which the data originator operates and tags from other entities in the industry, and
a third portion of tags based on user input;
obtaining, via the user interface, a selection of the at least one tag of the list of tags; and
generating, using the selection, the set of rules associated with each tag selected by the user.

3. The method of claim 1, wherein tagging the portion of the data comprises:
performing a multistage process in which information from the portion of the data is extracted to obtain extracted information and the extracted information is placed into a predefined format interpretable by a person.

4. The method of claim 3, wherein the multistage process comprises:
using the pre-trained model to obtain unstructured textual descriptions for the portion of the data, the unstructured textual descriptions being the information; and
using the template and a language model to refine the unstructured textual descriptions to obtain structured textual descriptions for the portion of the data to obtain the tagged portion of the data.

5. The method of claim 4, wherein the language model is adapted to populate the template based, at least in part, on the unstructured textual descriptions of information.

6. The method of claim 1, wherein the set of rules that are keyed to the tags are based, at least in part, on user input obtained using a user interface.

7. The method of claim 1, wherein the set of rules that are keyed to the tags are based on historical data and representative data, the representative data being from the data originator and the historical data from a different data originator.

8. The method of claim 1, wherein not providing the portion of the data to the remote entity comprises:
at least temporarily storing the tagged portion of the data locally, and marking the tagged portion of the data to prevent distribution to the remote entities.

9. The method of claim 1, wherein using at least one tag from the tagged portion of the data to refine the pre-trained model comprises:
ascribing, to the at least one tag, a negative reward, and
performing a reinforced learning process using the negative reward and the at least one tag to obtain an updated pre-trained model that is less likely to identify instances of the at least one tag in subsequently obtained portions of the data.

10. The method of claim 9, wherein the updated pre-trained model is adapted to identify were entities depicted in portions of the data than the pre-trained model is likely to identify.

11. The method of claim 10, wherein the pre-trained model is adapted to identify:
in video data:
activities depicted in a scene in the video data;
objects depicted in the scene in the video data;
relative positions of the objects;
in audio data:
speech using automated speech recognition and/or speech classification;
noise;
in textual data:
metadata regarding a document in which the textual data is stored.

12. A non-transitory machine-readable medium having instructions stored therein, which when executed by a processor, cause the processor to perform operations for managing data in a distributed system, the operations comprising:
obtaining, from a data originator of the distributed system, a portion of the data;
tagging, using a template and a pre-trained model, the portion of the data to obtain a tagged portion of the data;
making, using the tagged portion of the data and a set of rules keyed to tags that are applicable to the data within the distributed system, a determination regarding whether the portion of the data is to be provided to a remote entity of the distributed system that is remote to the data originator;
in a first instance of the determination where the portion of the data is not to be provided to the remote entity;
not providing the portion of the data to the remote entity, and
using at least one tag from the tagged portion of the data to refine the pre-trained model to reduce a likelihood of the pre-trained model tagging other portions of the data with any tags that are not deemed to be relevant by the set of the rules; and
in a second instance of the determination where the portion of the data is to be provided to the remote entity:
providing the portion of the data to the remote entity to provision computer implemented services using the data.

13. The non-transitory machine-readable medium of claim 12, wherein the operations further comprise:
prior to obtaining the portion of the data:
providing, to a user via a user interface, a list of tags to allow the user to select at least one tag of the list of tags, the list of tags comprising:
a first portion of tags based on a representative sample of the data,
a second portion of tags based on an industry in which the data originator operates and tags from other entities in the industry, and
a third portion of tags based on user input;
obtaining, via the user interface, a selection of the at least one tag of the list of tags; and
generating, using the selection, the set of rules associated with each tag selected by the user.

14. The non-transitory machine-readable medium of claim 12, wherein tagging the portion of the data comprises:
performing a multistage process in which information from the portion of the data is extracted to obtain extracted information and the extracted information is placed into a predefined format interpretable by a person.

15. The non-transitory machine-readable medium of claim 14, wherein the multistage process comprises:
using the pre-trained model to obtain unstructured textual descriptions for the portion of the data, the unstructured textual descriptions being the information; and
using the template and a language model to refine the unstructured textual descriptions to obtain structured textual descriptions for the portion of the data to obtain the tagged portion of the data.

16. The non-transitory machine-readable medium of claim 15, wherein the language model is adapted to populate the template based, at least in part, on the unstructured textual descriptions of information.

17. A data processing system, comprising:
a processor; and
a memory coupled to the processor to store instructions, which when executed by the processor, cause the processor to perform operations for managing data in a distributed system, the operations comprising:
obtaining, from a data originator of the distributed system, a portion of the data;
tagging, using a template and a pre-trained model, the portion of the data to obtain a tagged portion of the data;
making, using the tagged portion of the data and a set of rules keyed to tags that are applicable to the data within the distributed system, a determination regarding whether the portion of the data is to be provided to a remote entity of the distributed system that is remote to the data originator;
in a first instance of the determination where the portion of the data is not to be provided to the remote entity;
not providing the portion of the data to the remote entity, and
using at least one tag from the tagged portion of the data to refine the pre-trained model to reduce a likelihood of the pre-trained model tagging other portions of the data with any tags that are not deemed to be relevant by the set of the rules; and
in a second instance of the determination where the portion of the data is to be provided to the remote entity:
providing the portion of the data to the remote entity to provision computer implemented services using the data.

18. The data processing system of claim 17, wherein the operations further comprise:
prior to obtaining the portion of the data:
providing, to a user via a user interface, a list of tags to allow the user to select at least one tag of the list of tags, the list of tags comprising:
a first portion of tags based on a representative sample of the data,
a second portion of tags based on an industry in which the data originator operates and tags from other entities in the industry, and
a third portion of tags based on user input;
obtaining, via the user interface, a selection of the at least one tag of the list of tags; and
generating, using the selection, the set of rules associated with each tag selected by the user.

19. The data processing system of claim 17, wherein tagging the portion of the data comprises:
performing a multistage process in which information from the portion of the data is extracted to obtain extracted information and the extracted information is placed into a predefined format interpretable by a person.

20. The data processing system of claim 19, wherein the multistage process comprises:
using the pre-trained model to obtain unstructured textual descriptions for the portion of the data, the unstructured textual descriptions being the information; and
using the template and a language model to refine the unstructured textual descriptions to obtain structured textual descriptions for the portion of the data to obtain the tagged portion of the data.
